(19) United States
(12) Patent Application Publication
(10) Pub. No.: US 2009/0299957 A1
(43) Pub. Date: Dec. 3, 2009

(54) METHODS, APPARATUSES, AND COMPUTER PROGRAM PRODUCTS FOR PROVIDING AN AUDIBLE INTERFACE TO PUBLISH/SUBSCRIBE SERVICES

(75) Inventor: Jonathan Ledlie, Cambridge, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/131,546

(22) Filed: Jun. 2, 2008

(51) Int. Cl. G06F 17/30; G06F 7/06; G10L 13/08; G10L 15/26

(52) U.S. Cl. 707/2; 707/100; 707/5; 704/260; 704/235; 707/E17.014; 704/E13.001; 704/E15.043

(57) ABSTRACT

An apparatus may include a processor configured to receive content. The received content may at least partially comprise audio content. The processor may be further configured to generate an audible content posting from the received content. The processor may be additionally configured to store the generated audible content posting in a database comprising a publish/subscribe service. In some embodiments, the processor may be further configured to provide the audible content posting to remote device users via an audible interface to the publish/subscribe service.

### TECHNOLOGICAL FIELD

Embodiments of the present invention relate generally to mobile communication technology and, more particularly, relate to methods, apparatuses, and computer program products for providing a voicemail interface to publish/subscribe services.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the convenience to users is access to and use of publish/subscribe services. Publish/subscribe services may facilitate virtually instantaneous interaction with users of a network, such as the Internet, who may both publish new content and query existing published content. However, heretofore, user interfaces for such publish/subscribe services have been for the most part limited to access by Internet applications, such as a web browser, and display on visual display screens of computing devices.

Unfortunately, Internet access is not widely available in many parts of the world, such as in developing nations. Even in more industrialized nations, Internet access may not be available in certain areas. Furthermore, accessing publish/subscribe services may be somewhat time consuming, which may be costly for users of mobile devices, who may be charged per minute of Internet access. However, even in developing nations, cellular telephone service is much more widely available than Internet access. Some attempts have previously been made to attempt to harness the ubiquity of cellular telephone service to provide publish/subscribe services. These previous attempts have used short message service (SMS) messaging to facilitate user interaction with publish/subscribe services. For example, KAZI560 provides an SMS-based job listing service for residents of Kenya. However, these SMS-based publish/subscribe services have drawbacks in that many cellular service plans may charge a user per SMS message sent or received by the user. These charges may constitute a significant portion of an individual's income in a developing nation. Further, SMS messages are single-shot messages in that a user may receive a large quantity of information in a single SMS message, but in order to receive further information, a user may have to send an SMS message to the service provider requesting that the service provider send additional information in a subsequent SMS message. Accordingly, the lack of an ability for a user to iterate through an interactive interface may deter users from using SMS-based publish/subscribe services.

Although some previous attempts have been made to harness the ubiquity and ease of telephone voice communications, these previous attempts have generally failed to provide a comprehensive and intuitive publish/subscribe service accessible to a user of a mobile terminal. Accordingly, it may be advantageous to provide computing device users with methods, apparatuses, and computer program products for providing an audible interface to publish/subscribe services.

### BRIEF SUMMARY

A method, apparatus, and computer program product are therefore provided, which may provide for an audible interface for publish/subscribe services. In particular, a method, apparatus, and computer program product are provided to enable, for example, the generation of an audible content posting to a publish/subscribe service from user-submitted comment and the provision of audible content postings to users of the publish/subscribe service via an audible interface, such as may be accessed using a mobile terminal. In some embodiments, users may query stored audible content postings in the publish/subscribe service based at least in part upon a set of query criteria and may be provided with a plurality of audible content postings satisfying the query criteria.

In one exemplary embodiment, a method is provided which may include receiving content. The received content may at least partially comprise audio content. The method may further include generating an audible content posting from the received content. The method may additionally include storing the generated audible content posting in a database comprising a publish/subscribe service. In some embodiments, the method may also include providing the audible content posting to a remote device via an audible interface to the publish/subscribe service.

In another exemplary embodiment, a computer program product is provided. The computer program product includes at least one computer-readable storage medium having computer-readable program code portions stored therein. The computer-readable program code portions include first, second, and third program code portions. The first program code portion is for receiving content, wherein the received content at least partially comprises audio content. The second program code portion is for generating an audible content posting from the received content. The third program code portion is for storing the generated audible content posting in a database comprising a publish/subscribe service. In some embodiments, the computer-readable storage medium may further comprise a fourth program code portion for providing the audible content posting to a remote device via an audible interface to the publish/subscribe service.

In another exemplary embodiment, an apparatus is provided, which may include a processor. The processor may be configured to receive content. The received content may at least partially comprise audio content. The processor may be further configured to generate an audible content posting from the received content. The processor may be additionally configured to store the generated audible content posting in a database comprising a publish/subscribe service. In some embodiments, the processor may also be configured to provide the audible content posting to a remote device via an audible interface to the publish/subscribe service.

In another exemplary embodiment, an apparatus is provided. The apparatus may include means for receiving content, wherein the received content at least partially comprises audio content. The apparatus may further include means for generating an audible content posting from the received content. The apparatus may additionally include means for storing the generated audible content posting in a database comprising a publish/subscribe service.

In another exemplary embodiment, a method is provided. The method may include receiving a query request from a remote device. The query request may comprise a set of query criteria for filtering stored audible content postings based at least in part upon one or more classification parameters associated with each stored audible content posting. The method may further include providing a plurality of audible content postings satisfying the query criteria to the requesting remote device. In some embodiments, the method may further comprise storing the received query criteria and periodically querying stored audible content postings based at least in part upon the stored query criteria for additional audible content postings not previously provided to the requesting remote device use. In some embodiments, the method may additionally comprise providing the additional audible content postings satisfying the query criteria to the requesting remote device.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing an audible interface to publish/subscribe services; and

FIG. 4 is a flowchart according to an exemplary method for providing for an audible interface to publish/subscribe services according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

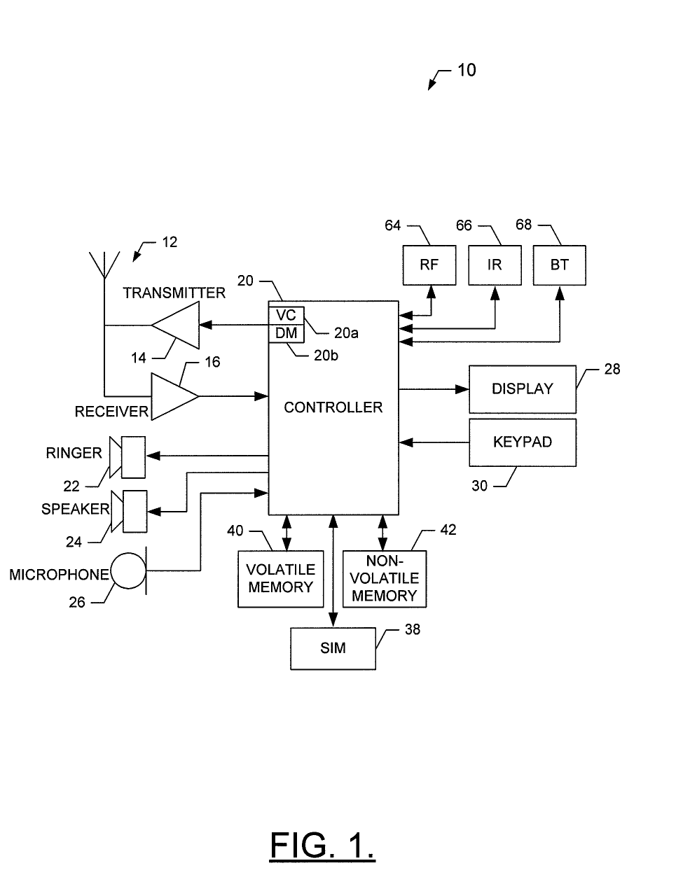

FIG. 1 illustrates a block diagram of a mobile terminal 10 that may benefit from embodiments of the present invention. It should be understood, however, that the mobile terminal illustrated and hereinafter described is merely illustrative of one type of electronic device that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 in communication with a transmitter 14 and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as UMTS, CDMA2000, WCDMA and TD-SCDMA. The mobile terminal may be additionally capable of operating in accordance with 3.9G wireless communication protocols such as LTE or E-UTRAN. Additionally, for example, the mobile terminal may be capable of operating in accordance with fourth-generation (4G) wireless communication protocols or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry desirable for implementing audio and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

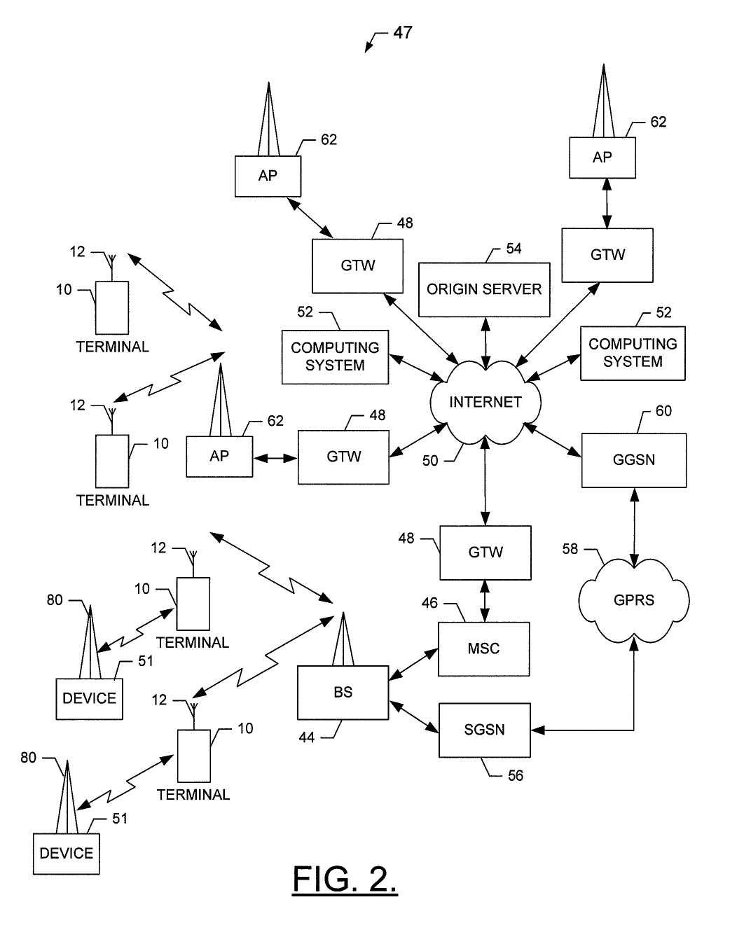

Referring now to FIG. 2, an illustration of one type of system that could support communications to and from an electronic device, such as the mobile terminal of FIG. 1, is provided by way of example, but not of limitation. As shown, one or more mobile terminals 10 may each include an antenna 12 for transmitting signals to and for receiving signals from a base site or base station (BS) 44. The base station 44 may be a part of one or more cellular or mobile networks each of which may comprise elements desirable to operate the network, such as a mobile switching center (MSC) 46. As well known to those skilled in the art, the mobile network may also be referred to as a Base Station/MSC/Interworking function (BMI). In operation, the MSC 46 may be capable of routing calls to and from the mobile terminal 10 when the mobile terminal 10 is making and receiving calls. The MSC 46 may also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and the present invention is not limited to use in a network or a network employing an MSC.

The MSC 46 may be coupled to a data network, such as a local area network (LAN), a metropolitan area network (MAN), and/or a wide area network (WAN). The MSC 46 may be directly coupled to the data network. In one example embodiment, however, the MSC 46 may be coupled to a gateway (GTW) 48, and the GTW 48 may be coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (two shown in FIG. 2), origin server 54 (one shown in FIG. 2) or the like, as described below.

As shown in FIG. 2, the BS 44 may also be coupled to a signaling General Packet Radio Service (GPRS) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as E-UTRAN or a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 and/or origin server 54 across the Internet 50, the mobile terminal 10, computing system 52 and origin server 54 may be coupled to one another and communicate in accordance with, for example, RF, BT, IrDA or any of a number of different wireline or wireless communication techniques, including LAN, WLAN, WiMAX, Wireless Fidelity (Wi-Fi), Wibree™, UWB techniques, and/or the like. One or more of the computing systems 52 may additionally, or alternatively, include a removable memory capable of storing content, which can thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, Wibree™, Wi-Fi, WLAN, WiMAX and/or UWB techniques. In this regard, the mobile terminal 10 may be capable of communicating with other devices via short-range communication techniques. For instance, the mobile terminal 10 may be in wireless short-range communication with one or more devices 51 that are equipped with a short-range communication transceiver 80. The electronic devices 51 may comprise any of a number of different devices and transponders capable of transmitting and/or receiving data in accordance with any of a number of different short-range communication techniques including but not limited to Bluetooth™, RFID, IR, WLAN, Infrared Data Association (IrDA) or the like. The electronic device 51 may include any of a number of different mobile or stationary devices, including other mobile terminals, wireless accessories, appliances, portable digital assistants (PDAs), pagers, laptop computers, motion sensors, light switches and other types of electronic devices.

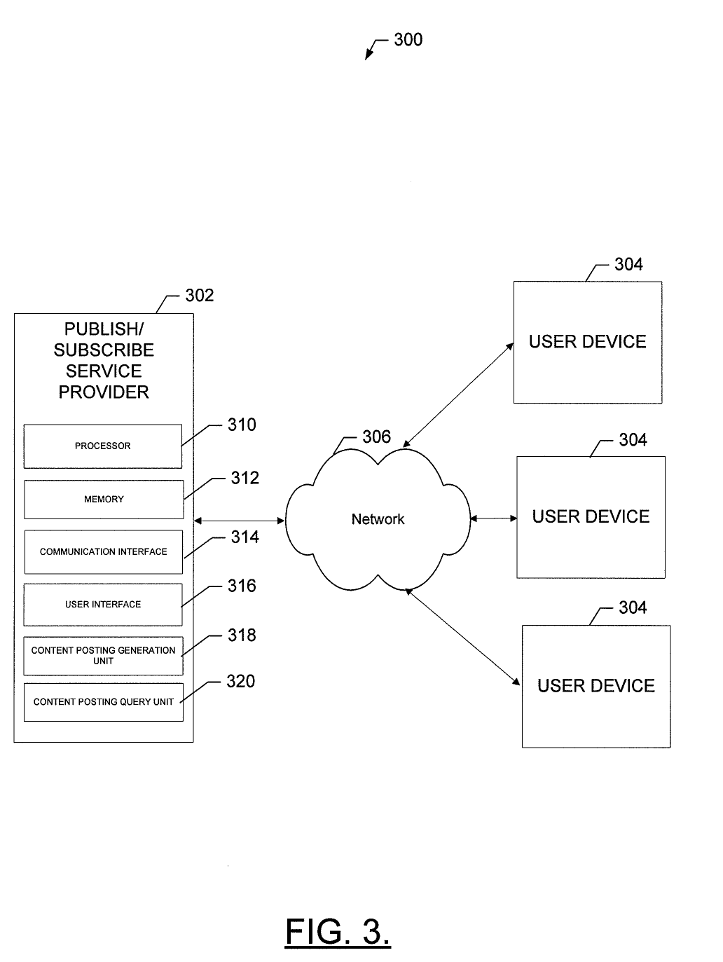

FIG. 3 illustrates a block diagram of a system 300 for providing an audible interface to publish/subscribe services. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. The system 300 will be described, for purposes of example, in connection with the mobile terminal 10 of FIG. 1 and the system 47 of FIG. 2. However, it should be noted that the system of FIG. 3, may also be employed in connection with a variety of other devices, both mobile and fixed, and therefore, embodiments of the present invention should not be limited to application on devices such as the mobile terminal 10 of FIG. 1. Further, it should be noted that the system of FIG. 3 may be used in connection with any of a variety of network configurations or protocols and is not limited to embodiments using aspects of the system 47 of FIG. 2. It should also be noted, that while FIG. 3 illustrates one example of a configuration of a system for providing an audible interface to publish/subscribe services, numerous other configurations may also be used to implement embodiments of the present invention.

Referring now to FIG. 3, the system 300 may include a publish/subscribe service provider (PSSP) 302 and a plurality of user devices 304 configured to communicate with each other over a network 306. PSSP 302 may be embodied as any computing device, mobile or fixed, and may be embodied as a server, desktop computer, laptop computer, mobile terminal 10, and/or the like. The PSSP 302 may also be embodied as a combination of a plurality of computing devices configured to provide a publish/subscribe service. In this regard, the PSSP 302 may be embodied, for example, as a server cluster and/or may be embodied as a distributed computing system, such as may be distributed across a plurality of computing devices, such as, for example, mobile terminals 10. As used herein, “publish/subscribe service” may include any service facilitating publishing of user-provided content such that the user-provided content may be accessed, such as by query, by other users of the publish/subscribe service. In this regard, for example, a publish/subscribe service may operate as an asynchronous messaging paradigm wherein senders (publishers) of messages may not be programmed to send their messages to specific receivers (subscribers). Rather, published messages may be characterized into categories, without knowledge of what (if any) subscribers there may be. Subscribers may express interest in one or more categories, and may accordingly only receive messages that are of interest, without knowledge of what (if any) publishers there are. In this regard, for example, users may express their interests through combinations of logical predicates or parameters that serve to filter results. A publish/subscribe service as used herein may, for example, operate as a continuous, asynchronous and/or on-going system. Examples of existing publish/subscribe services may include, for example, online message boards, message forums, electronic discussion groups, electronic discussion boards, discussion forums, Usenet, interactive bulletin boards, community blogs, electronic mailing lists, electronic classifieds providers such as Craigslist™, RSS feeds, and electronic auction sites. The user device 304 may be any computing device configured to access a publish/subscribe service, such as one provided by the PSSP 302, and in an exemplary embodiment, may be a mobile terminal 10. The network 306 may be any network over which the PSSP 302 and user device 304 are configured to communicate. Accordingly, the network 306 may be a wireless or wireline network and in an exemplary embodiment may comprise the system 47 of FIG. 2. The network 306 may further utilize any communications protocol or combination of communications protocols that may facilitate inter-device communication between the PSSP 302 and a user device 304. Additionally, although the system 300 illustrates one PSSP 302 and three user devices 304 for purposes of example, the system 300 may include a plurality of PSSPs 302 and/or user devices 304.

The PSSP 302 may include various means, such as a processor 310, memory 312, communication interface 314, user interface 316, content posting generation unit 318, and content posting query unit 320 for performing the various functions herein described. These various means may be distributed across a plurality of computing devices. Accordingly, for example, the content posting generation unit 318 and content posting query unit 320 may be embodied in separate computing devices. The processor 310 may be embodied in a number of different ways. For example, the processor 310 may be embodied as a microprocessor, a coprocessor, a controller, or various other processing elements including integrated circuits such as, for example, an ASIC (application specific integrated circuit) or FPGA (field programmable gate array). In an exemplary embodiment, the processor 310 may be configured to execute instructions stored in the memory 312 or otherwise accessible to the processor 310. Although illustrated in FIG. 3 as a single processor, the processor 310 may comprise a plurality of processors operating in parallel, such as a multi-processor system. In embodiments wherein the processor 310 is embodied as multiple processors, the processors may be embodied in a single computing device or distributed among multiple computing devices, such as a server cluster or amongst computing devices in operative communication with each other over a network.

The memory 312 may include, for example, volatile and/or non-volatile memory. The memory 312 may be configured to store information, data, applications, instructions, or the like for enabling the PSSP 302 to carry out various functions in accordance with exemplary embodiments of the present invention. For example, the memory 312 may be configured to buffer input data for processing by the processor 310. Additionally or alternatively, the memory 312 may be configured to store instructions for execution by the processor 310. As yet another alternative, the memory 312 may comprise one of a plurality of databases that store information in the form of static and/or dynamic information. In this regard, the memory 312 may store, for example, one or more databases comprising content postings of a publish/subscribe service. The memory 312 may additionally store a plurality of user profile data for users of a publish/subscribe service, such as users of user devices 304. In some embodiments, the user profile data may comprise stored query criteria and preferences defining categories and/or content that may be used by the content posting query unit 320 to filter content postings presented to a user. The user profile data may further comprise data about content postings that a user with which the particular user profile data is associated has accessed, such as indications, or flags. These flags may indicate, for example, that a content posting is flagged as “saved” in a user's profile data such that it may be accessed again by a user, or may alternatively indicate that a content posting is flagged as “deleted” in a user's profile data such that it will not again be presented to the user. This stored information may be stored and/or used by the content posting generation unit 318 and content posting query unit 320 during the course of performing their functionalities.

The communication interface 314 may be embodied as any device or means embodied in hardware, software, firmware, or a combination thereof that is configured to receive and/or transmit data from/to a network and/or any other device or module in communication with the PSSP 302. The communication interface 314 may be at least partially embodied as or otherwise controlled by the processor 310. In this regard, the communication interface 314 may include, for example, an antenna, a transmitter, a receiver, a transceiver and/or supporting hardware or software for enabling communications with other entities of the system 300, such as a user device 304 via the network 306. In this regard, the communication interface 314 may be in communication with the memory 312, user interface 316, content posting generation unit 318, and/or content posting query unit 320. The communication interface 314 may be configured to communicate using any protocol by which the PSSP 302 and user device 304 may communicate over the network 306 and such communications may comprise, for example, data messages, voice communications over a cellular network, and/or voice communications over internet protocol (VoIP). Accordingly, the communication interface 314 may provide means for receiving audio content, receiving data content, receiving a query request, providing audible content postings, and/or providing text-based content postings.

The user interface 316 may be in communication with the processor 310 to receive an indication of a user input and/or to provide an audible, visual, mechanical, or other output to the user. The user interface 316 may further be in communication with the content posting generation unit 318 and content posting query unit 320. Accordingly, the user interface 316 may facilitate access of and interaction with a publish/subscribe service, such as may be provided by the PSSP 302, by a user of a user device 304. In this regard, the user interface 316 may provide audible means for navigating existing content postings, such as those stored in memory 312, which may be provided by the content posting query unit 320 as described below, and for generating new content postings, which may be generated by the content posting generation unit 318 as described below. The user interface 316 may allow a user to interact with and provide content to a publish/subscribe service through audible commands, and/or dual tone multi-frequency (DTMF) signaling. In this regard, for example, the user interface 316 may receive commands and/or content provided by a user of a user device 304, such as audibly through a microphone of a user device 304, which may be, for example, a microphone 26 of a mobile terminal 10. Additionally or alternatively, the user interface 316 may receive commands and/or content via DTMF signals provided through a keypad of the user device 304. The user interface 316 may further be configured to communicate audible content postings as well as present audible menu options for navigating a publish/subscribe service to a user of a user device 304. In some embodiments, the user interface 316 may be further configured to receive text-based content from and provide text-based content postings to users of user devices 304, such as over a web interface and/or via SMS messaging, MMS messaging, instant messaging, e-mail, and/or the like.

The content posting generation unit 318 may be embodied as various means, such as hardware, software, firmware, or some combination thereof and, in one embodiment, may be embodied as or otherwise controlled by the processor 310. In embodiments where the content posting generation unit 318 is embodied separately from the processor 310, the content posting generation unit 318 may be in communication with the processor 310. The content posting generation unit 318 may be configured to process audio and/or DTMF content received via the user interface 316 and generate audible content postings. In this regard, a user may provide audio content, such as a plurality of spoken phrases intended to comprise an audible content posting to be posted on a publish/subscribe service.

A user may also provide a plurality of classification parameters associated with the received content that may be used by the content posting generation unit 318 to categorize a generated content posting within a publish/subscribe service. In this regard, a user of a user device 304 may provide a category for a content posting, such as, for example, sports discussion, apartment rental listing, or an item for sale. A user may further provide a plurality of subcategories for a content posting, such as, for example, a specific sports team, a number of bedrooms in an apartment, or a model of a car. These classification parameters may be received either audibly from a user of a user device 304 or may be received as DTMF inputs, such as in response to selecting an option from a plurality of menu options presented to a user device 304 by the content posting generation unit 318. The content posting generation unit 318 may be configured to generate an audible content posting based upon the plurality of associated classification parameters. In this regard, the content posting generation unit 318 may be configured to generate an audible content posting comprising the received classification parameters and the received spoken phrases. Accordingly, for example, the content posting generation unit 318 may be configured to automatically translate or otherwise adapt received classification parameters to audio content, such as spoken words. Additionally or alternatively, the content posting generation unit 318 may be configured to generate an audible content posting based upon the plurality of associated classification parameters such that the audible content posting is associated with indications of the plurality of received classification parameters.

The content posting generation unit 318 may further be configured to store a generated content posting in memory 312. In some embodiments, the content posting generation unit 318 may be configured to store the generated audible content posting, such as in memory 312, based upon the plurality of associated classification parameters. In this regard, the content posting generation unit 318 may be configured to store generated audible content postings in a database containing a plurality of fields, wherein each field corresponds to a classification parameter, and a generated audible content posting may be stored within the database based upon its associated classification parameters. Accordingly, the database may comprise a publish/subscribe service.

In an example use scenario, a user of a user device 304 wishing to post an audible content posting to a publish/subscribe service may call or otherwise establish a voice connection with the PSSP 302. The user may be provided via the user interface 316 with an audible menu comprising a plurality of selections, such as, for example “Create a new content posting” and “Query existing content postings.” If the user selects “create a new content posting,” the content posting generation unit 318 may then be configured to provide an audible menu comprising a plurality of options corresponding to categories or classification parameters. For example, one of these options may be “apartment listing.” If a user selects the apartment listing option, such as by speaking “apartment listing” or by pressing a key on the keypad corresponding to apartment listing, the content posting generation unit 318 may further sequentially provide a plurality of menus each comprising a plurality of options corresponding to sub-categories or classification parameters. Example sub-categories for an apartment listing may include, for example, a number of bedrooms and a location of the apartment. After a user has appropriately selected options from each of the option menus, the content posting generation unit 318 may be configured to audibly prompt the user over the user interface 316 to provide audio content to comprise the body or substance of an audible content posting. The user may then speak a few words describing the apartment as well as provide contact information, which the content posting generation unit 318 may capture and use to generate an audible content posting.

In another example use case scenario, the content posting generation unit 318 may additionally or alternatively be configured to receive an audible, such as spoken, phrase from a user device 304 via the user interface 316 and to parse one or more key words or phrases from the received audible phrase. For example, a user of a user device 304 may access the PSSP 302 and say “Post a two bedroom apartment for rent in Nairobi, Kenya for $200 per month.” The content posting generation unit 318 may then parse the key phrases “two bedroom,” “apartment,” “Nairobi, Kenya,” and “$200 per month” from the received spoken phrase and generate a content posting, such as an audible content posting, based upon the parsed phrases. In this regard, the content posting generation unit 318 may be configured to recognize a plurality of key words or phrases and to generate content postings based upon recognized key words or phrases. The received audible phrase may be received from a user live during an interactive use session with a user device 304 and/or may be received from a user device 304 as a part of a message, such as an audio message, e-mail, MMS message, voicemail, and/or the like.

In some embodiments, the content posting generation unit 318 may additionally be configured to generate audible content postings from received text-based content and classification parameters. Such text-based content and associated classification parameters may be received, for example, via a short message service (SMS) message, a multimedia message service (MMS) message, instant message (IM), e-mail, and/or over a web interface that may be provided by the user interface 316. In this regard, the content posting generation unit 318 may employ or comprise text-to-speech conversion logic such that received text-based content may be translated into audio content which the content posting generation unit 318 may use to generate an audible content posting.

Further, in some embodiments, the content posting generation unit 318 may be configured to generate text-based content postings. These text-based content postings may be generated directly from text-based content received as described above. Additionally or alternatively, the content posting generation unit 318 may employ or comprise speech-to-text conversion logic such that received audio content may be translated into text-based content which the content posting generation unit 318 may use to generate a text-based content posting. The content posting generation unit 318 may further be configured to store generated text-based content postings in memory 312 and in some embodiments may store generated text-based content postings based at least in part on associated classification parameters, such as in a database.

The content posting query unit 320 may be embodied as various means, such as hardware, software, firmware, or some combination thereof and, in one embodiment, may be embodied as or otherwise controlled by the processor 310. In embodiments where the content posting query unit 320 is embodied separately from the processor 310, the content posting query unit 320 may be in communication with the processor 310. The content posting query unit 320 may be configured to receive and process a query, such as may be received from a user of a user device 304, of a publish/subscribe service provided by the PSSP 302. A user query may simply comprise a selection of a single category of content postings which the content posting query unit 320 may then provide to the user. In this regard, if the content postings are audible content postings, the content posting query unit 320 may sequentially provide audio content postings within the selected category to the user. The content posting query unit 320 may provide the full audio of an audio content posting or may simply provide an audio title or summary of the audio content posting to a user, who may then optionally select, such as by providing an audio or DTMF command, to hear the entirety of an audio content posting of interest. A user may further select an option or otherwise indicate to the content posting query unit 320 to “skip” a content posting such that the content posting query unit 320 ceases providing the skipped content posting and proceeds to provide the next sequential content posting. Accordingly, in some embodiments, the content posting query unit 320 may provide a user with a plurality of options for each content posting. These options may include, for example, “skip,” “hear full content posting,” “save” (save operation is described further herein below), and/or “delete” (delete operation is described further herein below).

Additionally or alternatively, a user may provide a set of query criteria, which the content posting query unit 320 may use to filter content postings in the publish/subscribe service. In this regard, the set of query criteria may be used to filter content postings based at least in part on their associated classification parameters. Accordingly, for example, a user may desire to hear audible content postings advertising two-bedroom apartments for rent in Nairobi, Kenya. The content posting query unit 320 may accordingly be configured to filter stored content postings and provide those content postings that have associated classification parameters indicating apartments located in Nairobi, Kenya and having two bedrooms. A user may provide these query criteria either audibly, such as by speaking words comprising query criteria, or through DTMF commands, such as in response to an audible navigation menu provided by the content posting query unit 320 via the user interface 316.

The content posting query unit 320 may additionally be configured to store a received set of query criteria in memory 312. In this regard, the set of query criteria may be stored in association with a user profile for the user of the user device 304 from which the query criteria was received. This user profile may comprise, for example, a user's username or other publish/subscribe service user information, any configuration settings defining user preferences for accessing or navigating the publish/subscribe service, as well as indications of content postings which the user has already heard or viewed. The stored set of query criteria may then be used by the content posting query unit 320 to filter content postings added to the publish/subscribe service since the user's last visit and to provide the new content postings that satisfy the query criteria to the user. This subsequent filtering using stored query criteria may be performed at the request of the user, such as when the user next accesses the publish/subscribe service. Additionally or alternatively, the content posting query unit 320 may be configured to perform subsequent filtering based upon stored query criteria automatically, such as periodically. In this regard, the content posting query unit 320 may be configured to provide the user indication of additional available content postings satisfying his query criteria. This indication may comprise, for example, a phone call, flash message, SMS message, MMS message, IM, and/or e-mail indicating to the user that additional content postings are available for the user and prompting the user to access the publish/subscribe service to retrieve the additional content postings. As used herein, a “flash message” (sometimes referred to as “flashing” or “callback”) refers to calling a user device 304 and disconnecting the call connection before a user of the user device 304 answers the phone. Accordingly, for example, the content posting query unit 320 or some other element of the PSSP 302 may be configured to call a user device 304 to send a flash message indicating availability of content postings. Additionally or alternatively, the content posting query unit may be configured to directly provide new content postings satisfying the stored query criteria to the user. Audio content postings may be delivered, for example, to a voicemail box associated with the user, in MMS messages, embedded as attachments to an e-mail, and/or may be provided in an automated phone call to the user's user device 304. Text-based content postings may be provided to the user, for example, by SMS message, MMS message, IM, and/or e-mail.

The content posting query unit 320 may further be configured to store in association with a user's profile data in memory 312 indications of content postings that a user has heard or viewed. In this regard, upon hearing or viewing a content posting, a user may provide an indication whether the content posting is to be presented to the user in the future. These indications are referred to as “flags.” These flags may indicate that a content posting is flagged as “saved” in a user's profile data such that it may be accessed again by a user, or may alternatively indicate that a content posting is flagged as “deleted” in a user's profile data such that it will not again be presented to the user. A “saved” content posting may be saved by the content posting query unit 320 to a user's profile either by association or directly, such that the user may immediately access a saved content posting from a cache of saved content postings in the user's user profile data. Additionally or alternatively, a saved content posting may be delivered by the content posting query unit 320 to a user, such as via voicemail, MMS message, SMS message, IM, and/or e-mail such that the user may access the message outside of the publish/subscribe service. Further, the content posting query unit 320 may flag a content posting such that, while not directly saved so that a user may immediately access the content posting, the content posting may be provided in response to a subsequent query comprising query criteria satisfied by the content posting even though the user has previously heard or viewed the content posting. The content posting query unit 320 may further be configured to receive a rating indication of a content posting from a user and store the rating indication as a flag in association with the content posting. In this regard, a rating may be a numerical indication, such as, for example on a scale of 1-5, indicating a user's interest level in the content posting. Thus in some embodiments, a saved content posting may also include a flag indicating the user's interest level in the saved content posting. The content posting query unit 320 may further be configured to receive an indication from a user to delete one or more saved flags such that a subsequent query will return results including previously deleted items. In this regard, the deletion of saved flags may be on a per-content posting, per-query, or per-subscription (i.e. delete all saved flags for the user) basis.

The content posting query unit 320 may further be configured to provide one user's saved flags to a user device 304 associated with a second user, such as in response to a request of a first user. In this regard, a first user may provide flagged content postings of interest to a second user. For example, a first user of a user device 304 may notice a content posting that he thinks may be of interest to a second user. The user may then flag the content posting for the second user, for example, by providing the other user's username, identification number, real world name, and/or other indicia while flagging the content posting. The content posting query unit 320 may then be configured to use the provided indicia to determine the second user's service account information and/or a means of providing the flagged content posting to the second user and to provide the flagged content posting to the second user, such as, for example, when the second user next accesses the publish/subscribe service. Additionally or alternatively, the content posting query unit 320 may be configured to receive from (such as by receiving voice and/or DTMF signals) and/or provide to the first user a code or password and associate that code or password with the flagged content posting. Accordingly, the content posting query unit 320 and/or the first user may provide the code or password to a second user and the second user may use the code or password to directly access the flagged content posting. In this regard, the content posting query unit 320 may further be configured to receive a code, password, or other indicia associated with a content posting from a user accessing the publish/subscribe service and to provide the associated content posting to the user.

Although illustrated in FIG. 3 and described herein as being embodied on the PSSP 302, the content posting query unit 320 may be at least partially embodied on the user device 304. In this regard, a user may query and flag content postings locally stored on a user device 304, such as in volatile memory 40 or non-volatile memory 42 of a mobile terminal 10. Accordingly, the processor 310 or other element of the PSSP 302 may be configured to provide a user device 304 with a plurality of content posting stored in memory 312, such as on a subscription basis. A user of a user device 304 may then query, save, delete, or otherwise flag the locally stored content postings. Accordingly, any of the above described content posting query unit 320 functions may be executed on a user device 304 in addition to or in lieu of execution on the PSSP 302.

In an example use scenario, a user accessing a publish/subscribe service provided by the PSSP 302 may be provided via the user interface 316 with an audible menu comprising a plurality of selections, such as, for example “Create a new content posting” and “Query existing content postings.” If the user selects “query existing content postings,” the content posting query unit 320 may then be configured to provide an audible menu comprising a plurality of options corresponding to categories or classification parameters. For example, one of these options may be “apartment listings.” If a user selects the apartment listings option, such as by speaking “apartment listings” or by pressing a key on the keypad corresponding to apartment listings, the content posting query unit 320 may further sequentially provide a plurality of menus each comprising a plurality of options corresponding to sub-categories or classification parameters. Accordingly, the user may select a location, such as Nairobi, Kenya. The user may then subsequently select an option for two-bedroom apartments. The content posting query unit 320 may then, for example, sequentially provide audible content postings for two-bedroom apartments in Nairobi, Kenya. It will be appreciated that sequential provision of audible content postings is merely for example and embodiments of the invention are not so limited. In this regard, the content posting query unit 320 may be configured to provide audible or other content postings in any order. In some embodiments rather than the content posting query unit 320 providing the user with the full audio content of each audible content posting, the content posting query unit 320 may provide a user only with audio content comprising a title or summary of the audible content posting. The user may then indicate whether he wishes to hear the full audible content posting or to skip the content posting. Further, upon hearing an audible content posting the user may be provided with a plurality of options, which may include, for example options to “save,” “delete,” and/or “flag” the audible content posting. These options may be presented, for example, such that a user may press the “9” key of his user device 304 to save an audible content posting, press the “7” key of the user device 304 to delete an audible content posting, or press the “5” key of the user device 304 to flag an audible content posting. It will be appreciated, however, that a user “deleting” a content posting does not delete it from the publish/subscribe service, but rather merely flags the content posting such that it will not again be provided to that particular user.

In another example use case scenario, the content posting query unit 320 may additionally or alternatively be configured to receive an audible, such as spoken, phrase from a user device 304 and to parse one or more key words or phrases from the received audible phrase for use as query criteria. For example, a user of a user device 304 may access the PSSP 302 and say “Provide me with two bedroom apartments in Nairobi, Kenya.” The content posting query unit 320 may then parse the key phrases “two bedroom,” “apartments,” and “Nairobi, Kenya” from the received spoken phrase and query stored content postings based upon the parsed phrases. In this regard, the content posting query unit 320 may be configured to recognize a plurality of key words or phrases and to provide content postings and/or query stored content postings based upon recognized key words or phrases. The received audible phrase may be received from a user live during an interactive use session with a user device 304 and/or may be received from a user device 304 as a part of a message, such as an audio message, e-mail, MMS message, voicemail, and/or the like.

In an exemplary embodiment, the PSSP 302 may be configured to present a different publish/subscribe service and/or a different section of a publish/subscribe service based upon the location of the user accessing the PSSP 302. In this regard, for example, the PSSP 304 may be comprised of a plurality of individual computing devices, each of which stores content postings and provides a publish/subscribe service for a particular location or region, or may be a single computing device wherein the content postings are stored in memory 312 based upon a location or region associated with the content posting or with the user who contributed the content posting. Accordingly, when a user accesses a publish/subscribe service provided by the PSSP 302, the PSSP 302 may include means, such as the processor 310 or user interface 316 for determining the user's location. The user's location may be determined from a user's stored profile data or the user may be prompted to select a location when accessing the publish/subscribe service. Additionally or alternatively, the user's location may be determined based upon the user device 304 used to access the publish/subscribe service. In this regard, the user device 304 may be associated with a telephone number and the location may be determined from an area code or country code of the telephone number. The user device 304 may additionally or alternatively be associated with an internet protocol (IP) address from which the user accesses the publish/subscribe service. As another alternative, the user device 304 may communicate with the PSSP 302 over a cellular network and a location may be determined using the cell identification of the cell through which the user device 304 is connected to the cellular network. Further, a location may be determined through global positioning system (GPS) or assisted-GPS coordinate determinations of a position of the user device 304, which may be determined by a GPS module embodied on the user device 304 or through cell triangulation. The coordinates of the user device 304 may then be communicated to the PSSP 302 either directly by the user device 304 or by another device of the network 306. Based upon a determined location of the user, the user interface 316 may be configured to provide a publish/subscribe service customized to the user's location, such as by providing only content postings associated with the user's location.

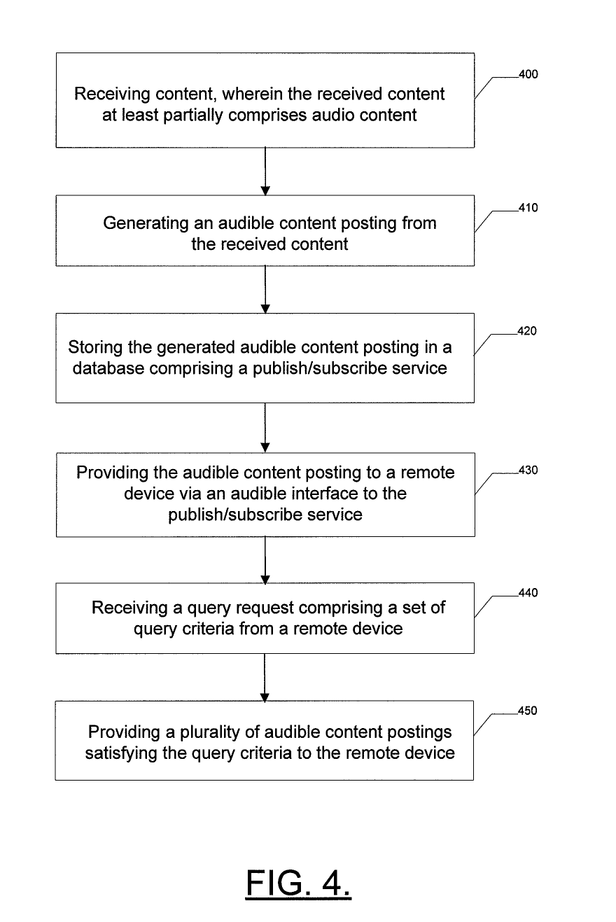

FIG. 4 is a flowchart of a system, method, and computer program product according to an exemplary embodiment of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a built-in processor in the computing device. In some embodiments, the computer program instructions which embody the procedures described above may be stored by memory devices of a plurality of computing devices. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowcharts, and combinations of blocks or steps in the flowchart, may be implemented by special purpose hardware-based computer systems which perform the specified functions or steps, or combinations of special purpose hardware and computer instructions.

In this regard, one exemplary method for providing for an audible interface to publish/subscribe services according to an exemplary embodiment of the present invention is illustrated in FIG. 4. It will be appreciated, however, that the following operations may be performed by either a single device or multiple devices. In this regard, for example, operations 400-450 may be performed by a single computing device or alternatively, for example, operations 400-420 may be performed by a first computing device and operations 430-450 may be performed by a second computing device. The method may optionally include the content posting generation unit 318 receiving content via the communication interface 314 at operation 400. The received content may at least partially comprise audio content. Operation 410 may comprise the content posting generation unit 318 generating an audible content posting from the received content. The content posting generation unit 318 may then store the generated audible content posting in a database, such as in memory 312, comprising a publish/subscribe service. Operation 430 may comprise providing the audible content posting to remote device users via an audible interface (i.e. the user interface 316) to the publish/subscribe service. In this regard, users may interact with the publish/subscribe service and the audible content posting may be communicated to the user through the communication interface 314, such as in response to a user query request processed by the content posting query unit 320. Operation 440 may comprise the content posting query unit 320 receiving via the communication interface 314 a query request comprising a set of query criteria from a user of a user device 304. The content posting query unit may then provide a plurality of audible content postings satisfying the query criteria to the remote device user at operation 450.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal 10. Embodiments of the invention may provide for an audible interface to a publish/subscribe service. Accordingly, users in areas where traditional internet facilitated publish/subscribe services are not readily available or are cost prohibitive may utilize a publish/subscribe service. Further, such an audible publish/subscribe service may benefit visually impaired users who may not be able to read traditional text-based content postings of existing publish/subscribe services. Additionally, embodiments of the present invention may provide a unified publish/subscribe service which users may access and contribute to via both audible and text-based interfaces.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving content, wherein the received content at least partially comprises audio content;
generating an audible content posting from the received content; and
storing the generated audible content posting in a database comprising a publish/subscribe service.

2. A method according to claim 1, wherein:
receiving content further comprises receiving a plurality of classification parameters associated with the received content;
generating an audible content posting further comprises generating the audible content posting based at least in part upon the plurality of associated classification parameters; and
storing the generated audible content posting further comprises storing the generated audible content posting based at least in part upon the plurality of associated classification parameters; and further comprising providing the audible content posting to a remote device via an audible interface to the publish/subscribe service based at least in part upon the plurality of associated classification parameters.

3. A method according to claim 2, further comprising:
receiving a query request from a remote device, wherein the query request comprises a set of query criteria for filtering stored audible content postings based at least in part upon their associated classification parameters; and
providing a plurality of audible content postings satisfying the query criteria to the requesting remote device.

4. A method according to claim 3, further comprising receiving an indication from the requesting remote device whether to save for later review or delete an audible content posting;
wherein if the indication indicates that an audible content posting is to be saved, the audible content posting is flagged in association with a user of the requesting remote device so that the remote device user may access the saved audible content posting at a later time; and
wherein if the indication indicates that an audible content posting is to be deleted, the audible content posting is flagged so that it will not subsequently be provided in response to a query request of the requesting remote device user even if the content posting satisfies the query criteria of the query request.

5. A method according to claim 3, further comprising:
storing the received query criteria;
periodically querying stored audible content postings based at least in part upon the stored query criteria for additional audible content postings not previously provided to the requesting remote device; and
providing the additional audible content postings satisfying the query criteria to the requesting remote device.

6. A method according to claim 5, wherein providing the additional audible content postings comprises delivering the additional audible content postings to a voicemail box associated with a user of the requesting remote device.

7. A method according to claim 5, further comprising notifying a user of the requesting remote device of the additional audible content postings via a flash message, short message service message, e-mail, instant message, or telephone call.

8. A method according to claim 1, further comprising
receiving text-based content;
translating the received text-based content to audio content; and
wherein generating an audible content posting comprises generating the audible content posting from the translated audio content.

9. A method according to claim 1, further comprising:
translating the audible content posting to a text-based content posting; and
providing the text-based content posting to a remote device.

10. A computer program product comprising at least one computer-readable storage medium having computer-readable program code portions stored therein, the computer-readable program code portions comprising:
a first program code portion for receiving content, wherein the received content at least partially comprises audio content;
a second program code portion for generating an audible content posting from the received content; and
a third program code portion for storing the generated audible content posting in a database comprising a publish/subscribe service.

11. A computer program product according to claim 10, wherein:
the first program code portion includes instructions for receiving a plurality of classification parameters associated with the received content;
the second program code portion includes instructions for generating the audible content posting based at least in part upon the plurality of associated classification parameters; and
the third program code portion includes instructions for storing the generated audible content posting based at least in part upon the plurality of associated classification parameters; and further comprising
a fourth program code for providing the audible content posting to a remote device via an audible interface to the publish/subscribe service based at least in part upon the plurality of associated classification parameters.

12. A computer program product according to claim 11, further comprising:
a fifth program code portion for receiving a query request from a remote device, wherein the query request comprises a set of query criteria for filtering stored audible content postings based at least in part upon their associated classification parameters; and
a sixth program code portion for providing a plurality of audible content postings satisfying the query criteria to the requesting remote device.

13. A computer program product according to claim 12, further comprising:
a seventh program code portion for receiving an indication from the requesting remote device whether to save for later review or delete an audible content posting;
wherein if the indication indicates that an audible content posting is to be saved, the audible content posting is flagged in association with a user of the requesting remote device so that the remote device user may access the saved audible content posting at a later time; and
wherein if the indication indicates that an audible content posting is to be deleted, the audible content posting is flagged so that it will not subsequently be provided in response to a query request of the requesting remote device user even if the content posting satisfies the query criteria of the query request.

14. A computer program product according to claim 12, further comprising:
a seventh program code portion for storing the received query criteria;
an eighth program code portion for periodically querying stored audible content postings based at least in part upon the stored query criteria for additional audible content postings not previously provided to the requesting remote device; and
a ninth program code portion for providing the additional audible content postings satisfying the query criteria to the requesting remote device.

15. A computer program product according to claim 14, wherein the ninth program code portion includes instructions for delivering the additional audible content postings to a voicemail box associated with a user of the requesting remote device.

16. A computer program product according to claim 14, further comprising:
a tenth program code portion for notifying a user of the requesting remote device of the additional audible content postings via a flash message, short message service message, e-mail, instant message, or telephone call.

17. A computer program product according to claim 10, further comprising:
a fifth program code portion for receiving text-based content;
a sixth program code portion for translating the received text-based content to audio content; and
wherein the second program code portion includes instructions for generating the audible content posting from the translated audio content.

18. A computer program product according to claim 10, further comprising:
a fifth program code portion for translating the audible content posting to a text-based content posting; and
a sixth program code portion for providing the text-based content posting to a remote device.

19. An apparatus comprising a processor configured to:
receive content, wherein the received content at least partially comprises audio content;
generate an audible content posting from the received content; and
store the generated audible content posting in a database comprising a publish/subscribe service.

20. An apparatus according to claim 19, wherein the processor is further configured to:
receive a plurality of classification parameters associated with the received content;
generate an audible content posting by generating the audible content posting based at least in part upon the plurality of associated classification parameters;
store the generated audible content posting by storing the generated audible content posting based at least in part upon the plurality of associated classification parameters; and
provide the audible content posting to a remote device via an audible interface to the publish/subscribe service based at least in part upon the plurality of associated classification parameters.

21. An apparatus according to claim 20, wherein the processor is further configured to:
receive a query request from a remote device, wherein the query request comprises a set of query criteria for filtering stored audible content postings based at least in part upon their associated classification parameters; and
provide a plurality of audible content postings satisfying the query criteria to the requesting remote device.

22. An apparatus according to claim 21, wherein the processor is further configured to receive an indication from the requesting remote device whether to save for later review or delete an audible content posting;
wherein if the indication indicates that an audible content posting is to be saved, the audible content posting is flagged in association with a user of the requesting remote device so that the remote device user may access the saved audible content posting at a later time; and
wherein if the indication indicates that an audible content posting is to be deleted, the audible content posting is flagged so that it will not subsequently be provided in response to a query request of the requesting remote device user even if the content posting satisfies the query criteria of the query request.

23. An apparatus according to claim 21 wherein the processor is further configured to:
store the received query criteria;
periodically query stored audible content postings based at least in part upon the stored query criteria for additional content postings not previously provided to the requesting remote device; and
provide the additional audible content postings satisfying the query criteria to the requesting remote device.

24. An apparatus according to claim 23 wherein the processor is further configured to provide the additional audible content postings by delivering the additional audible content postings to a voicemail box associated with a user of the requesting remote device.

25. An apparatus according to claim 23, wherein the processor is further configured to notify a user of the requesting remote device of the additional audible content postings via flash message, a short message service message, e-mail, instant message, or telephone call.

26. An apparatus according to claim 19, wherein the processor is further configured to:
receive text-based content;
translate the received text-based content to audio content; and
wherein the processor is configured to generate an audible content posting from the translated audio content.

27. An apparatus according to claim 19, wherein the processor is further configured to:
translate the audible content posting to a text-based content posting; and
provide the text-based content posting to a remote device.

28. An apparatus comprising:
means for receiving content, wherein the received content at least partially comprises audio content;
means for generating an audible content posting from the received content; and
means for storing the generated audible content posting in a database comprising a publish/subscribe service.

29. A method comprising:
receiving a query request from a remote device, wherein the query request comprises a set of query criteria for filtering stored audible content postings in a publish/subscribe service based at least in part upon one or more classification parameters associated with each stored audible content posting; and
providing a plurality of audible content postings satisfying the query criteria to the requesting remote device.

30. A method according to claim 29, further comprising receiving an indication from the requesting remote device whether to save for later review or delete an audible content posting;
wherein if the indication indicates that an audible content posting is to be saved, the audible content posting is flagged in association with a user of the requesting remote device so that the remote device user may access the saved audible content posting at a later time; and
wherein if the indication indicates that an audible content posting is to be deleted, the audible content posting is flagged so that it will not subsequently be provided in response to a query request of the requesting remote device user even if the content posting satisfies the query criteria of the query request.

31. A method according to claim 30, further comprising:
storing the received query criteria;
periodically querying stored audible content postings based at least in part upon the stored query criteria for additional audible content postings not previously provided to the requesting remote device; and
providing the additional audible content postings satisfying the query criteria to the requesting remote device.
